(19) United States
(12) Patent Application Publication
(10) Pub. No.: US 2022/0063695 A1
(43) Pub. Date: Mar. 3, 2022

(54) PUSHCART DISPOSABLE HANDLE COVER

(71) Applicants: DANIEL HAIGLER, Indian Trail, NC (US); Joel Thomas, Ft. Lauderdale, NC (US)

(72) Inventors: DANIEL HAIGLER, Indian Trail, NC (US); Joel Thomas, Ft. Lauderdale, NC (US)

(21) Appl. No.: 17/461,396

(22) Filed: Aug. 30, 2021

Related U.S. Application Data
(60) Provisional application No. 63/072,283, filed on Aug. 31, 2020.

(51) Int. Cl. B62B 5/06; B32B 15/08

(52) U.S. Cl. CPC B62B 5/069; B32B 2250/03; B32B 2571/00; B32B 15/08

(57) ABSTRACT

The present invention is a disposable cover that wraps around a pushcart handle, which protects the pushcart operators using the pushcart from possible contagions on the pushcart handle. The core components of the invention are the malleable metal, bendable frame, plastic cover. The invention can be used to protect pushcart operators from conditions, dirt, and possible disease-spreading methods on a pushcart at grocery stores, home supply stores, or other locations where pushcarts are re-used by multiple pushcart operators. Furthermore, it should be noted that this allows the store, or provider of pushcarts, to reduce workloads and cleaning items should they choose to provide the handles. Some stores may use them as a giveaway with their logo and pushcart operators would use the handle at another location. Pushcart operators will also feel safer as the handle they are using has been in their possession and is free from contagions.

### RELATED APPLICATIONS

This application claims priority to U.S. Provisional Patent Application No. 63/072,283, filed on Aug. 31, 2020, which is incorporated herein by reference in its entirety, including any addendums, appendixes, and attachments thereto, to the extent this application does not conflict with the present disclosure herein.

### BACKGROUND

The following discussion is not to be deemed admitted prior art but merely related art to show possible background and information related to pushcart handle covers.

Currently, there are a number of solutions for pushcart handle covers. Some of these solutions attempt to protect pushcart operators by using foam with a slit that can be slid over a pushcart handle. Still other solutions are simple paper and adhesive methods. Still other solutions are nothing more than wiping a handle with a disinfectant cloth. These solutions fail to meet the needed solution because they are difficult to use, not disposable, difficult to manufacture, or require holding the pushcart to apply pressure when using the solution.

Therefore, a need exists for a disposable, easy to use, and low cost pushcart disposable handle cover system.

### BRIEF SUMMARY OF THE INVENTION

The invention relates generally to pushcart disposable handle covers.

It is desirable to have a disposable pushcart handle cover that protects pushcart operators from contagions when using pushcarts. Furthermore, it is desirable to dispose of the pushcart handle cover after each use. Still, further, it is desirable to have an easy to attach method to minimize any contamination from possible contagions. Still, further, it is desirable to have an easy to attach method to speed attaching the cover and not slow the shopping process or queue. Still, further, it is advantageous to have a pushcart disposable handle cover system that could be manufactured in rolls or sheets.

The disposable pushcart handle cover will be available to pushcart operators in sheets or freestanding rolls. A merchant may provide these for consumers or a consumer may have their own supply.

The disclosed device advantageously fills these needs and addresses the aforementioned deficiencies by providing a protective layer between the pushcart and pushcart operators that can be readily disposed of after use.

### BRIEF DESCRIPTION OF THE DRAWINGS

The present invention is illustrated by way of example, and not by way of limitation, in the figures of the accompanying drawings.

While aspects of the present invention will be described with reference to the details of the embodiments of the invention shown in the drawings (and some embodiments not shown in the drawings), these details are not intended to limit the scope of the invention.

FIG. 1. A perspective view of a pushcart disposable handle cover system attached to a standard shopping cart.

FIG. 2. A perspective view of a pushcart disposable handle cover system attached to a standard utility cart found in do-it-yourself stores.

FIG. 3. A perspective view of the preferred basic embodiment of the invention's components, unassembled.

FIG. 4. A planar view of the preferred basic embodiment of the invention's components, assembled.

FIG. 5. A perspective view of another embodiment of the invention's components, unassembled.

FIG. 6. A planar view of another embodiment of the invention's components, assembled.

FIG. 7. A perspective view of the preferred embodiment of the invention in a proposed manufacturing process.

### LIST OF FIGURE ITEMS

1 A pushcart handle cover
2 A pushcart
3 A standard utility cart
4 An inner material
5 An outer material, bottom or top
6 An outer material, top or bottom
7 A length describing the outer material
8 A width describing the outer material
9 A length describing the inner material
10 A width describing the inner material
12 A spar
13 A brace

### DETAILED DESCRIPTION

The present invention is directed to pushcart disposable handle cover systems.

The order of the steps of disclosed processes may be altered within the scope of the invention.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The pushcart disposable handle cover system may, however, be embodied in many different forms and should not be construed as being limited to the embodiments set forth herein; rather, these embodiments are provided by way of illustration only and so that this disclosure will be thorough, complete and fully convey understanding to those skilled in the art.

For the purposes of promoting an understanding of the principles of the pushcart disposable handle cover system, reference will now be made to the embodiments illustrated in the drawings and specific language will be used to describe the same, only as examples and not intended to be limiting.

Pushcarts, as used herein may be, but are not limited to, grocery carts, utility carts, strollers, shopping buggies, cart, trolley, shopping trolley, carriage, dolly, caddie, shopping basket, wagon, trolley car, rolling cart, wire trolley, basket trolley, or market basket.

Disclosed is a pushcart disposable handle cover system, which is made up of the following components: (1) an inner layer of malleable and ductile metal such that the metal is flexible, soft, workable, supple, and bendable like, but not limited to aluminum foil, and of such length equal to or similar to the width of a pushcart handle and width equal to one to three times the circumference of a pushcart handle with the left and right sides being substantially parallel to each other and the top and bottom sides being substantially parallel to each other; (2) an outer layer, top and bottom, of a ductile, flexible, soft, workable, supple, bendable material like, but not limited to, plastic material slightly larger in size than the inner material with a length approximately equal to a pushcart handle and width equal to one to three times the circumference of a pushcart handle. These components are connected as follows: (1) one sheet of the outer layer laid flat; (2) the inner layer laid on the outer layer longitudinally to generally match the same direction; (3) the second layer of the outer material laid over the prior inner and outer material layers in the same direction with the edges of the outer layers matching each; (4) each layer connected to the prior layer with an adhesive which could be glue.

The pushcart disposable handle cover system may also have one or more of the following: (1) thin braces made of different materials, like but not limited to, plastic, metal, bamboo, fibrous wood to provide rigidity running longitudinally and parallel to the top and bottom lengths of the outer material; (2) a layer of padding material between the inner layer and the top outer layer to provide cushioning of the pushcart operator's hands such as, but not limited to, foam, polyurethane, air, or cellulose; (3) thin spars interconnecting the optional thin braces to provide additional rigidity; (4) the multiple layers may be joined together, in some versions of the invention, by alternate methods like a heat-molded process; (5) and a method of assembly of flat sheets with perforations separating one pushcart disposable handle cover system from the next.

The disclosed device is unique when compared with other known devices and no solutions because it provides: (1) protection for the operators of a pushcart; (2) ease of use with different kinds of pushcarts; (3) disposability after use; and (4) it does not require an adhesive material to adhere to the pushcart handle.

The disclosed device is unique in that it is structurally different from other known devices or solutions. More specifically, the device is unique due to the presence of (1) a malleable metal material between the two outer material layers; (2) stiffening braces running longitudinally; (2) is made with materials to allow disposability.

In its most complete version, the device is made up of the following components: malleable metal material, wire or braces, material to protect the operators of the pushcart, adhesive, padding, spars, and a method to hold everything together. These components are connected as follows: (1) a ductile, flexible, soft, workable, supple, bendable outer material with a length approximately equal to a pushcart handle, and the width is just larger than the circumference up to several times the circumference of a pushcart handle, and of such width to allow for optional padding; (2) two thin braces are run longitudinally, generally parallel and near the edges of the material, and adhered to the shapable article, with possible additional thin braces at intervals approximately the distance apart of the circumference of the pushcart handle; (3) a malleable, ductile, flexible, soft, workable, supple, shapable inner material approximate in size to the outer material is laid generally parallel to the edges of the outer material and attached with an adhesive; (4) a layer of cushioning material is laid over the prior outer material, thin braces and metal-like material and held in place with an adhesive; (4) the second layer of outer material is laid over the top of the prior elements in a parallel fashion and in such a way that the edges match the edges of the first outer material using an adhesive; (5) the edges are further pressed or connected to bond together the entire device.

In some embodiments of the invention, the outer material may be, but not limited to plastic, polyethylene, silicone, beeswax-coated cloth, tissue paper, wax paper, paper, or cardboard.

In some embodiments of the invention, the inner material may be, but not limited to aluminum, aluminum foil, copper, tin, gold, silver, nickel, brass, metalized polyester, or a metal mesh.

In some embodiments of the invention, the thin braces are made of metal whereas in other versions the braces may be made of, but not limited to, plastic, bamboo, fibrous wood, carbon fiber, or cardboard.

In some embodiments of the invention, the spars are made of metal whereas in other versions the braces may be made of, but not limited to, plastic, bamboo, fibrous wood, carbon fiber, or cardboard.

In some embodiments of the invention, the cushioning material is made of compressed polyester, whereas in other versions the braces may be made of, but not limited to, polyester fiberfill, medium density polyurethane antimicrobial foam, high density polyurethane foam, dry fast open cell foam, closed cell foam, fabric backed sew foam, or pockets of air.

In some embodiments of the invention, the edges of the top and bottom outer 150 material may be connected by one of several methods such as folding, hemming, stitching, heat sealing, adhesive, or any other such method to ensure the entire device is securely bonded together.

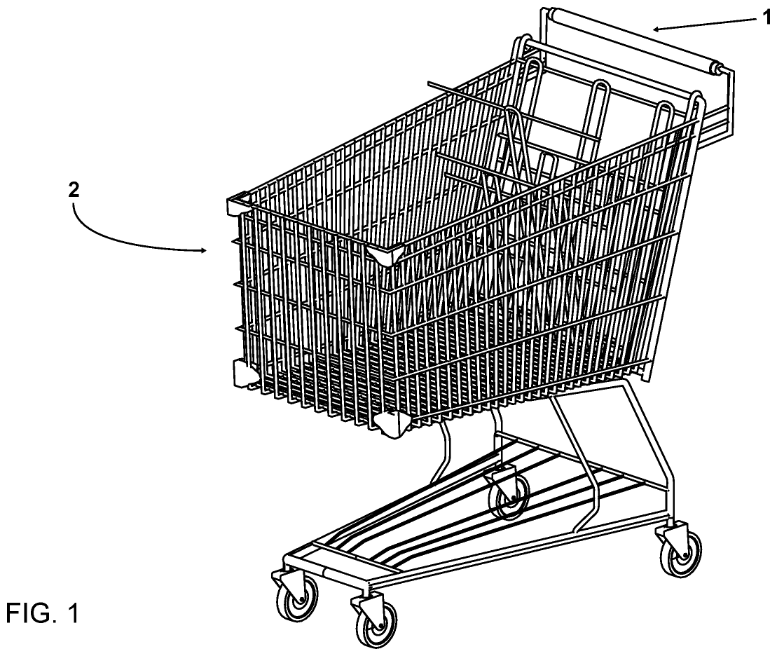

FIG. 1—Exhibits the pushcart disposable handle cover system 1 for a standard pushcart 2, also considered a shopping cart, buggy, or other type of rolling device like a stroller. The pushcart disposable handle cover system 1 is wrapped around the handle of the shopping cart 2 and provides a protective barrier between the pushcart operator's hands and any possible contagions that could be found on the shopping cart 2.

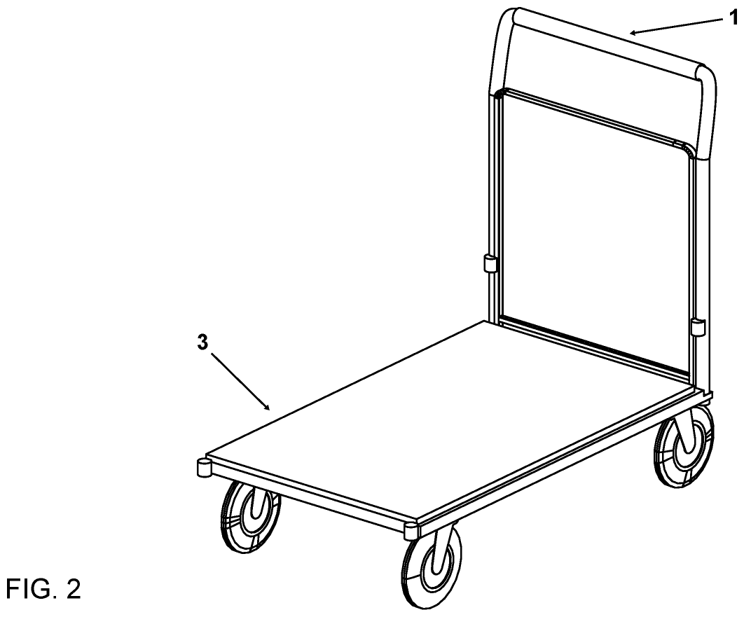

FIG. 2—Exhibits the pushcart disposable handle cover system 1 for a standard utility cart 3, of the type typically found in warehouse do-it-yourself, builder supply, or grocery stores. The pushcart disposable handle cover system 1 is wrapped around the handle of the utility cart 3 and provides a protective barrier between the pushcart operator's hands and any possible contagions that could be found on the utility cart 3.

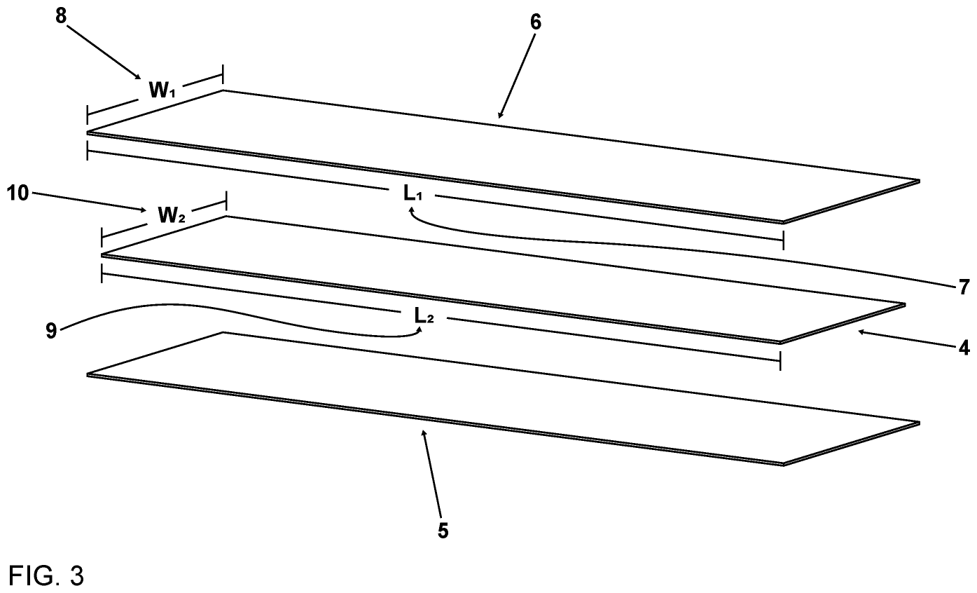

FIG. 3—Shows the components of the preferred embodiment of the invention. One layer of the outer material 5 is laid flat having a length 7 approximately equal to the width of a pushcart handle and a width 8 equal to one to three times the circumference of a pushcart handle. An inner material 4 with length 9, slightly smaller than length 7, and width 10, slightly smaller than width 8, is laid on the said outer material 5 and connected using an adhesive. The second layer of outer material 6 is then laid on the said prior materials 5, 6 and connected using adhesive. The dimensions given are for reference only and not meant to limit the size or application of the device.

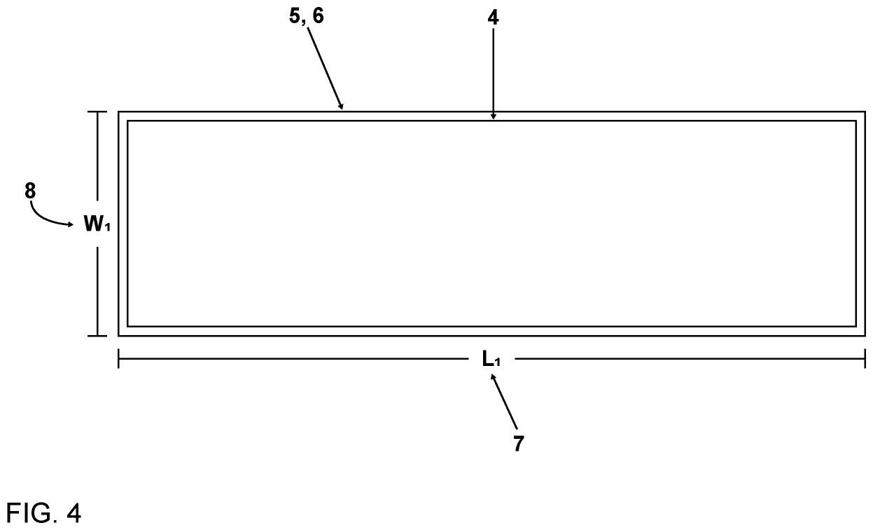

FIG. 4—Shows the preferred embodiment of the invention after assembly. The inner material 4 is bonded between the two layers of outer materials 5, 6 having a length 7 approximately equal to the width of a pushcart handle and a width 8 equal to one to three times the circumference of a pushcart handle. The dimensions given are for reference only and not meant to limit the size or application of the device.

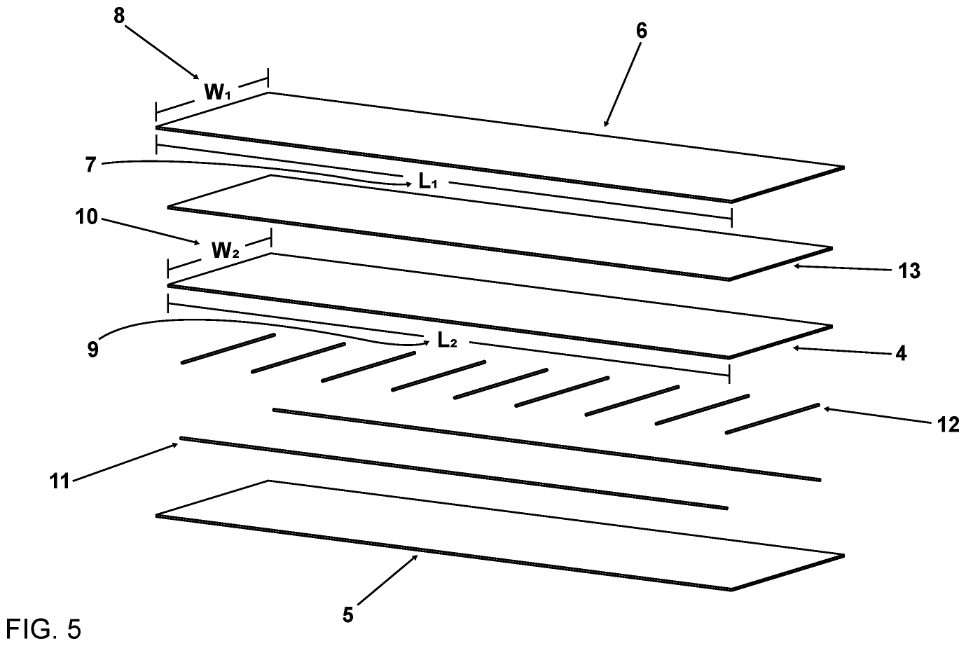

FIG. 5—Shows the components of an alternate embodiment of the invention. One layer of the outer material 5 is laid flat having a length 7 approximately equal to the width of a pushcart handle and a width 8 equal to one to three times the circumference of a pushcart handle. Thin braces 11 are laid longitudinally and parallel on the previous layer 5. Thin spars 12 are laid perpendicular to the prior thin braces 11. An inner material 4 with length 9, slightly smaller than length 7, and width 10, slightly smaller than width 8, is laid on the said outer material 5, braces 11, spars 12, and connected using an adhesive. A cushioning material 13 is next laid on the previously assembled layers. The second layer of outer material 6 is then laid on the said prior materials 5, 6 and connected using adhesive. The dimensions given are for reference only and not meant to limit the size or application of the device.

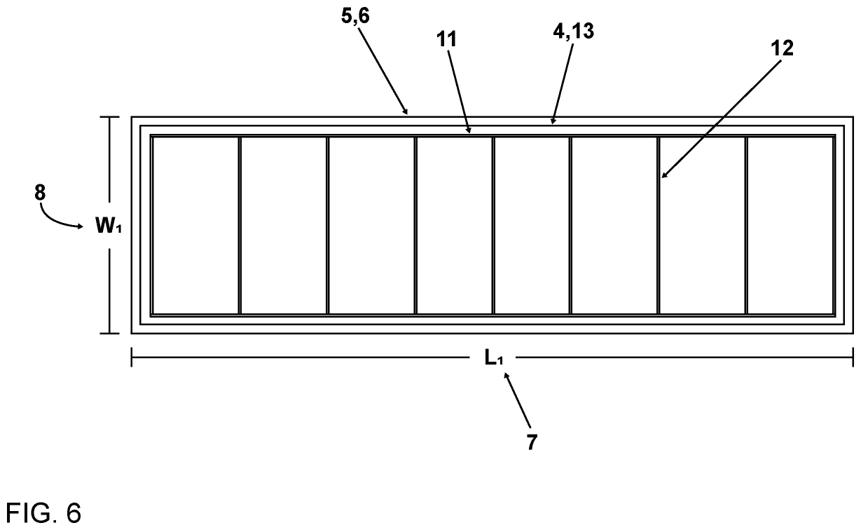

FIG. 6—Shows the components of an alternate embodiment of the invention in its assembled form. The inner material 4 is bonded between the two layers of outer materials 5, 6 having a length 7 approximately equal to the width of a pushcart handle and a width 8 equal to one to three times the circumference of a pushcart handle. The thin braces 11 run parallel and longitudinally and spars 12 are set perpendicular to the braces 11. A cushioning material 13 is contained within the layers. The dimensions given are for reference only and not meant to limit the size or application of the device.

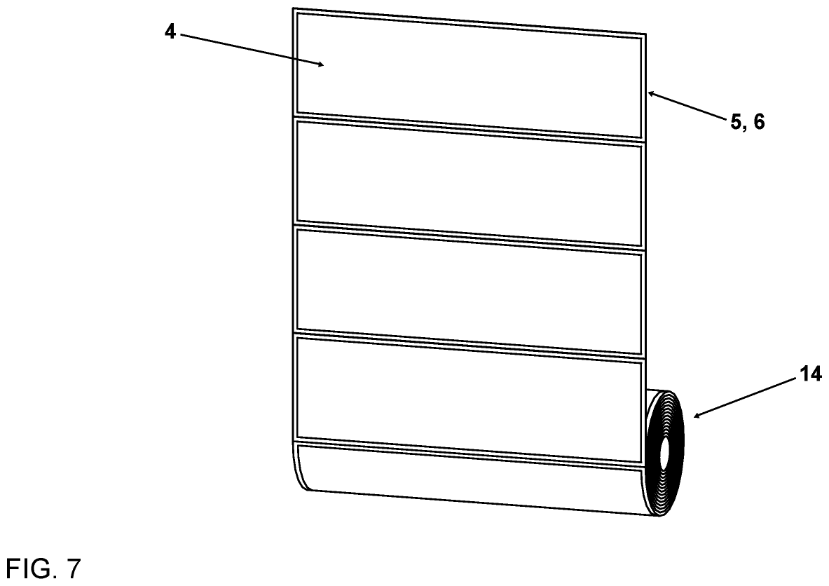

FIG. 7—Shows the preferred embodiment of the invention after assembly and on a proposed roll 14 in the manufacturing process. The inner material 4 is bonded between the two layers of outer materials 5, 6. A perforation may be made in the outer materials 5,6.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

The embodiments of the present invention may be utilized individually, concurrently, or in any sequential combination.

Those skilled in the art to which this application relates will appreciate that other and further additions, deletions, substitutions and modifications may be made to the described embodiments.

The specification is not to be taken in a limiting sense, but is made merely for the purpose of describing the general principles of exemplary embodiments; many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

The invention is described with such embodiments, but the invention is not limited to any embodiment. The scope of the invention is limited only by the claims and the invention encompasses numerous alternatives, modifications and equivalents. Several specific details are set forth in the description to provide a thorough understanding of the invention. These details are provided for the purpose of example and the invention may be practiced according to the claims without some or all of these specific details. In general, the order of the steps of disclosed processes may be altered within the scope of the invention.

Unless otherwise indicated, the drawings are intended to be read (e.g., arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing FIG. faces the reader. Similarly, the terms “inwardly” and “outwardly” generally refer to the orientation of a surface relative to its axis of elongation, or axis of rotation, as appropriate. Also, as used herein, terms such as “positioned on” or “supported on” mean positioned or supported on but not necessarily in direct contact with the surface.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure. Any alterations and further modifications in the illustrated devices, and such further application of the principles of the invention as illustrated herein are contemplated as would normally occur to one skilled in the art to which the invention relates.

What is claimed:

1. A pushcart disposable handle cover system, comprising:
an outer bottom layer of a given length and width;
an outer top layer of a given length and width of same size as said bottom layer; and
an inner layer of a given length and width attached between said outer layers.

2. A pushcart disposable handle cover system of claim 1 further comprising:
a layer of cushioning material of a given length and width connected between said inner and outer layer.

3. A pushcart disposable handle cover system of claim 1 further comprising:
a plurality of braces of a given length longitudinally and parallel to said inner and outer layer is connected between said inner layer and outer layers; and
a plurality of spars of a given length perpendicular and parallel to said inner and outer layer is connected between said inner layer and outer layers.

4. The pushcart disposable handle cover system of claim 1 wherein said outer layer further comprising:
a ductile, flexible, soft, workable, supple, bendable material.

5. The pushcart disposable handle cover system of claim 1 wherein said inner layer further comprising:
a ductile, flexible, soft, workable, supple, bendable material.

6. A method of adapting a pushcart with a pushcart disposable handle cover system device, comprising:
selecting a pushcart appropriate for use with the pushcart disposable handle cover system; and
using a pushcart disposable handle cover system comprising an outer layer; and an inner layer; and
wherein connecting the pushcart disposable handle cover system to said pushcart results in protecting the pushcart user when using the pushcart.
